(19) United States
(12) Patent Application Publication
(10) Pub. No.: US 2012/0027009 A1
(43) Pub. Date: Feb. 2, 2012

(54) COMMUNICATION DEVICE AND METHOD THEREOF

(75) Inventors: ZHEN-HUA XIONG, SHANGHAI (CN); YU-CHAN NIEH, Tu-Cheng (TW)

(73) Assignees: HON HAI PRECISION INDUSTRY CO., LTD., Tu-Cheng (TW); AMBIT MICROSYSTEMS (SHANGHAI) LTD., SHANGHAI (CN)

(21) Appl. No.: 12/940,006

(22) Filed: Nov. 4, 2010

(30) Foreign Application Priority Data
Jul. 30, 2010 (CN) 201010242098.3

(51) Int. Cl. H04L 12/66; H04M 3/42

(52) U.S. Cl. 370/352; 379/211.01; 379/211.01

(57) ABSTRACT

A communication device electronically connects with a phone and includes a control unit, a relay, a public switched telephone network (PSTN) interface, a voice over Internet Protocol (VoIP) network interface, and a ring signal detector. The relay is electronically connected with the control unit. The PSTN interface and the VoIP interface are electronically connected with the relay. The ring signal detector is electronically connected with the control unit and the PSTN interface. The control unit controls the relay to connect the phone with the PSTN interface when the ring signal detector detects a PSTN ring signal. In one embodiment, the control unit controls the relay to connect the phone with the VoIP interface.

### BACKGROUND

1. Technical Field

The present disclosure relates to a communication device capable of automatically connecting a phone to different communication networks.

2. Description of Related Art

Integrated access devices (IADs) are popularly used for connecting a phone to different communication networks. The IADs include a voice over Internet Protocol (VoIP) interface and a public switch telephone network (PSTN) interface. A phone cable of the phone is manually connected with the VoIP interface for VoIP communication requirements, and is manually connected with the PSTN interface for PSTN communication requirements. The requirements for such manual connections are inconvenient.

### BRIEF DESCRIPTION OF THE DRAWINGS

FIG. 1 is a block diagram of one embodiment of a communication device.

FIG. 2 is a block diagram of one embodiment of a ring signal detector of FIG. 1.

FIG. 3 is a flowchart illustrating one embodiment of a method for automatically connecting a phone to different communication networks.

### DETAILED DESCRIPTION

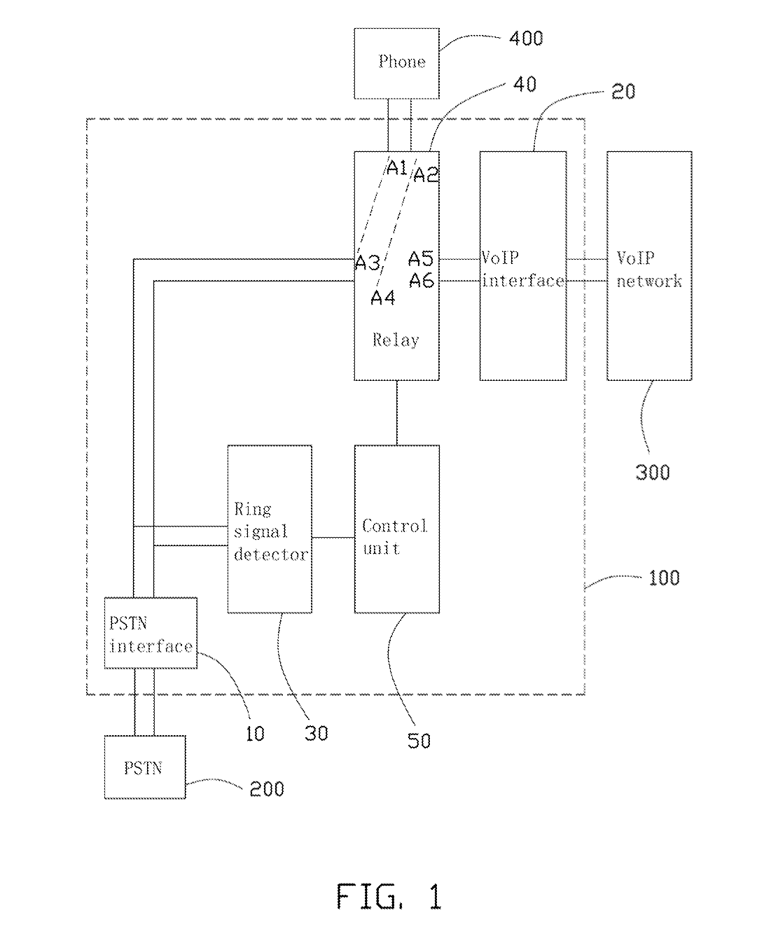

FIG. 1 is a block diagram of one embodiment of a communication device 100. The communication device 100 is capable of connecting a phone 400 to a public switch telephone network (PSTN) 200 and a voice over Internet Protocol (VoIP) network 300. The communication device 100 includes a PSTN interface 10, a VoIP interface 20, a ring signal detector 30, a relay 40, and a control unit 50. In the embodiment, the communication device 100 is an integrated access device (IAD).

The PSTN interface 10 is configured to communicate with the PSTN 200 and is electronically connected with the relay 40. The VoIP interface 20 is configured to communicate with the VoIP network 300 and is electronically connected with the relay 40. The ring signal detector 30 is configured to detect a PSTN ring signal from the PSTN 200, and is electronically connected with the PSTN interface 10 and the control unit 50. The relay 40 is electronically connected with the control unit 50.

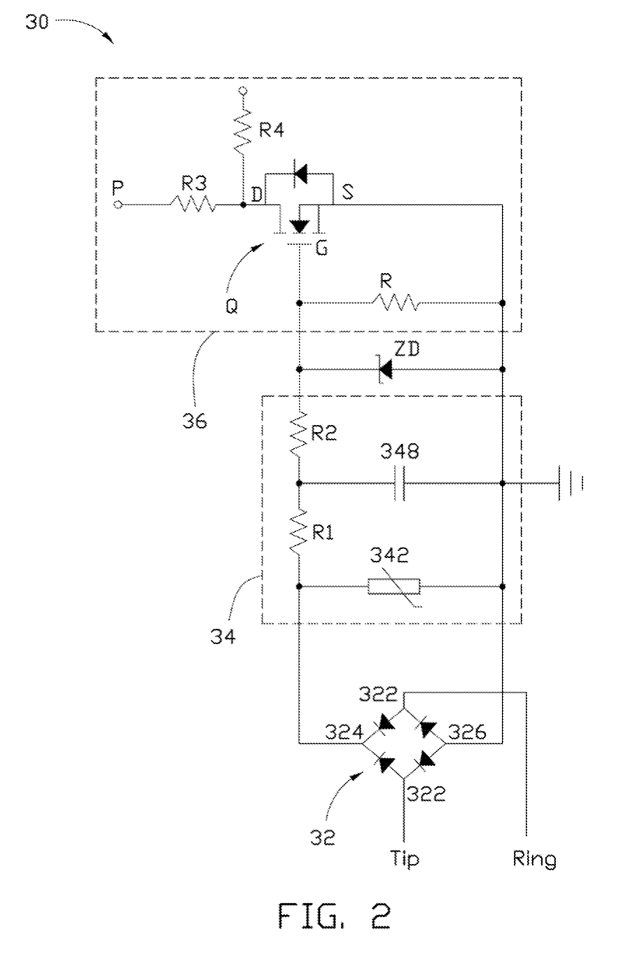

FIG. 2 is a block diagram of one embodiment of the ring signal detector 30 of FIG. 1. The ring signal detector 30 includes a positive wire Tip, a negative wire Ring, a bridge rectifier 32, a protection circuit 34, a Zener diode ZD, and a trigger circuit 36. The positive wire Tip and the negative wire Ring are both electronically connected with the PSTN interface 10 and the bridge rectifier 32, and configured to receive the PSTN ring signal. The bridge rectifier 32 includes two input terminals 322, an output terminal 324, and a ground terminal 326. The two input terminals 322 are individually electronically connected with the positive wire Tip and the negative wire Ring, and configured to receive the PSTN ring signal. The bridge rectifier 32 may transform the PSTN ring signal into a direct current (DC) signal and output the DC signal through the output terminal 324. The ground terminal 326 is connected to ground.

The protection circuit 34 includes a varistor 342, a first resistor R1, a second resistor R2, and a capacitor 348. The varistor 342 is electronically connected with the output terminal 324 and the ground terminal 326 of the bridge rectifier 32. When the ring signal detector 30 receives a surge voltage, the varistor 342 may generate a short circuit to protect the ring signal detector 30. The first resistor R1 and the second resistor R2 are used to provide current limiting for the PSTN ring signal. The first resistor R1 is electronically connected in series with the second resistor R2, and is electronically connected with the varistor 342 and the output terminal 324.

The capacitor 348 is used for filtering. One terminal of the capacitor 348 is electronically connected between the first resistor R1 and the second resistor R2, and other terminal of the capacitor 348 is connected to ground. The Zener diode ZD and the capacitor 348 are electronically connected in parallel. A negative terminal of the Zener diode ZD is electronically connected with the second resistor R2, and a positive terminal of the Zener diode ZD is connected to ground. When the voltage of the PSTN ring signal exceeds a breakdown voltage of the Zener diode ZD, the Zener diode ZD is in a reverse breakdown state. As a result, voltages of two terminals of the Zener diode ZD remain constant to stabilize the voltage of the PSTN ring signal.

The trigger circuit includes a bias resistor R, a field-effect transistor (FET) Q, a power supply P, a third resistor R3, and a fourth resistor R4. The bias resistor R is electronically connected in parallel with the Zener diode ZD, and provides the FET Q with a bias voltage. The FET Q includes a gate terminal G, a source terminal S, and a drain terminal D. The gate terminal G, the bias resistor R, and the negative terminal of the Zener diode ZD are electronically connected together. The source terminal S is connected to ground. The drain terminal D is individually electronically connected with the power supply P and the control unit 50 through the third resistor R3 and the fourth resistor R4.

The voltage of the power supply P can be 3.3V, for example. The fourth resistor R4 is configured to prevent the control unit 50 from being damaged by large currents. When the PSTN ring signal flows through the Zener diode ZD, the Zener diode ZD is in a reverse breakdown state and the voltage of the Zener diode ZD remains substantially constant. As a result, the voltage of the gate terminal G exceeds the voltage of the source terminal S, and the FET Q is turned on. After the FET Q is turned on, the current flows from the drain terminal D to the source terminal S, and therefore the voltage of the drain terminal D decreases. The voltage of the drain terminal D during the FET Q is turned on is a low electric potential signal relative to that during the FET Q is turned off. The FET Q is turned off when no PSTN ring signal is received. The voltage of the drain terminal D during the FET Q is turned off is a high electric potential signal relative to that during the FET Q is turned on.

The relay 40 includes connection terminals A1-A6. The connection terminals A1 and A2 are electronically connected with the phone 400 through a voice interface (not shown). The connection terminals A3 and A4 are electronically connected with the PSTN interface 10. The connection terminals A5 and A6 are electronically connected with the VoIP interface 20.

The control unit 50 may be a central processing unit (CPU) of the communication device 100, and is electronically connected with the relay 40. The control unit 50 may detect the voltage of the drain terminal D and control the relay 40 based on the voltage of the drain terminal D. When detecting the low electric potential signal outputted from the drain terminal D, the control unit 50 connects the connection terminals A1 and A2 with the connection terminals A3 and A4. The phone 400 may be connected to the PSTN 200. When detecting the high electric potential signal outputted from the drain terminal D, the control unit 50 connects the connection terminals A1 and A2 with the connection terminals A5 and A6. The phone 400 may be connected to the VoIP network 300.

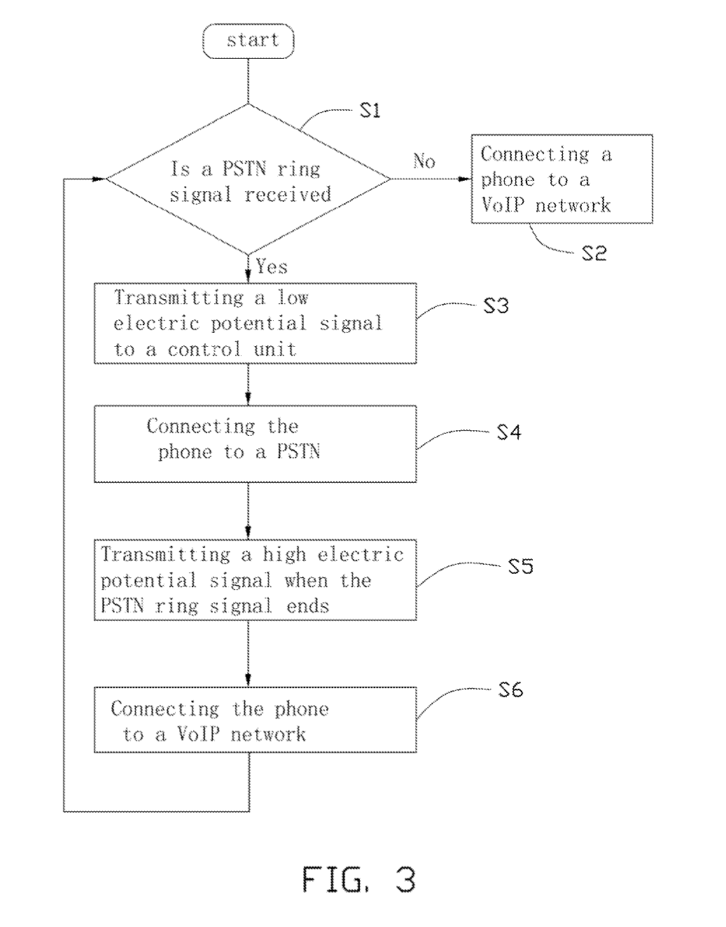

FIG. 3 is a flowchart illustrating one embodiment of a method for automatically connecting the phone 400 to different communication networks. Depending on the embodiment, additional blocks may be added, others removed, and the ordering of the blocks may be changed.

In block S1, the ring signal detector 30 determines whether the PSTN ring signal is received. If no PSTN ring signal is received, in block S2, the control unit 50 control the relay 40 to connect the phone 400 to the VoIP network 300.

If the PSTN ring signal is received, in block S3, the ring signal detector 30 triggers the low electric potential signal and transmits the low electric potential signal to the control unit 50.

In block S4, the control unit 50 controls the relay 40 to connect the phone 400 to the PSTN 200.

In block S5, the ring signal detector 30 triggers the high electric potential signal and transmits the high electric potential signal to the control unit 50 when the PSTN ring signal ends.

In block S6, the control unit 50 control the relay 40 to connect the phone 400 to the VoIP network 300, and block S1 is repeated.

The present disclosure provides a communication device to automatically connect a phone to a PSTN or a VoIP network for different requirements. Manual switching between the PSTN and the VoIP network for the phone may be avoided.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A communication device capable of electronically connecting with a phone, comprising:
a control unit;
a relay electronically connected with the control unit;
a public switched telephone network (PSTN) interface electronically connected with the relay;
a voice over Internet Protocol (VoIP) network interface electronically connected with the relay; and
a ring signal detector electronically connected with the control unit and the PSTN interface, and is configured to detect a PSTN ring signal;
wherein the control unit controls the relay to connect the phone with the PSTN interface and the VoIP interface.

2. The communication device of claim 1, wherein the ring signal detector transmits a low electric potential signal to the control unit when the PSTN ring signal is received, and the control unit controls the relay to connect the phone with the PSTN interface.

3. The communication device of claim 2, wherein the ring signal detector transmits a high electric potential signal to the control unit when the PSTN ring signal ends, and the control unit controls the relay to connect the phone with the VoIP interface.

4. The communication device of claim 1, wherein the ring signal detector comprises:
a bridge rectifier configured to transform the PSTN ring signal into a direct current (DC) signal;
a Zener diode configured to stabilize the voltage of the DC signal;
a protection circuit;
a trigger circuit electronically connected with the control unit and the Zener diode, and configured to trigger the low electric potential signal;
a positive wire electronically connected with the PSTN interface and the bridge rectifier; and
a negative wire electronically connected with the PSTN interface and the bridge rectifier.

5. The communication device of claim 4, wherein the protection circuit comprises a varistor; a first resistor; a second resistor; and a capacitor; and
wherein the varistor is electronically connected with the bridge rectifier and is connected to ground;
wherein the first resistor is electronically connected in series with the second resistor, and is electronically connected with the varistor;
wherein the capacitor is electronically connected in parallel with the Zener diode, is electronically connected between the first resistor and the second resistor, and is connected to ground.

6. The communication device of claim 5, wherein a negative terminal of the Zener diode is electronically connected with the second resistor, and a positive terminal of the Zener diode is connected to ground.

7. The communication device of claim 4, wherein the trigger circuit comprises a bias resistor; a field-effect transistor (FET); a power supply; a third resistor; and a fourth resistor; and
wherein the FET comprises a gate terminal, a source terminal, and a drain terminal;
wherein the gate terminal is electronically connected with the bias resistor;
wherein the source terminal is connected to ground; and
wherein the drain terminal is individually electronically connected with the power supply and the control unit through the third resistor and the fourth resistor.

8. The communication device of claim 7, wherein the FET is turned on when the PSTN ring signal flows through the PSTN interface, and is turned off when no PSTN ring signal flows through the PSTN interface.

9. A computer-implemented method for connecting a phone to a public switched telephone network (PSTN) and a voice over Internet Protocol (VoIP) network, the method comprising:
determining whether a PSTN ring signal is received;
transmitting a low electric potential signal when the PSTN ring signal is received; and
connecting the phone to the PSTN based on the low electric potential signal.

10. The method of claim 5, further comprising:
connecting the phone to the VoIP network when no PSTN ring signal is received.

11. The method of claim 5, further comprising:
transmitting a high electric potential signal when the PSTN ring signal ends.

12. The method of claim 7, further comprising:
connecting the phone to the VoIP network based on the high electric potential signal.
